(19) United States
(12) Patent Application Publication
(10) Pub. No.: US 2015/0054966 A1
(43) Pub. Date: Feb. 26, 2015

(54) IMAGING DEVICE USING PIXEL ARRAY TO SENSE AMBIENT LIGHT LEVEL & METHODS

(71) Applicant: Samsung Electronics Co., Ltd., Suwon-si (KR)

(72) Inventor: Yibing M. WANG, Temple City, CA (US)

(73) Assignee: Samsung Electronics Co., Ltd., Suwon-si (KR)

(21) Appl. No.: 14/108,313

(22) Filed: Dec. 16, 2013

Related U.S. Application Data
(60) Provisional application No. 61/869,018, filed on Aug. 22, 2013.

(51) Int. Cl. H04N 17/00

(52) U.S. Cl. CPC H04N 17/002
USPC 348/187

(57) ABSTRACT

Imaging devices and methods detect ambient light level using array pixels. In one embodiment, an imaging device includes an array of imaging pixels that are configured to acquire an image, and an array of dark pixels. A controller may cause at least one of the imaging pixels and of the dark pixels to image concurrently. A monitoring circuit may measure a difference between currents drawn by the imaging pixel and the dark pixel during the concurrent imaging. An indication of ambient light level can be generated according to the difference. The indication can be used as desired, for example to manage the brightness of the display screen. As such, no separate sensors are required, apart from the imaging array that is already provided for imaging.

### CROSS REFERENCE TO RELATED PATENT APPLICATIONS

This patent application claims priority from U.S. Provisional Patent Application Ser. No. 61/869,018, filed on Aug. 22, 2013, titled: “USING RGB CMOS IMAGE SENSOR FOR AMBIENT LIGHT DETECTION”, the disclosure of which is hereby incorporated by reference for all purposes.

### BACKGROUND

Mobile devices have display screens that can be used under different conditions of ambient light level. They detect the amount of ambient light level, and they manage the brightness of the display screen accordingly. Such solutions have been given in the past, for example in U.S. Pat. Nos. 8,008,613 and 8,076,628.

### BRIEF SUMMARY

The present description gives instances of imaging devices and methods, the use of which may help overcome problems and limitations of the prior art.

In one embodiment, an imaging device includes an array of imaging pixels that are configured to acquire an image, and an array of dark pixels. A controller may cause at least one of the imaging pixels and at least one of the dark pixels to image concurrently. A monitoring circuit may measure a difference between currents drawn by the imaging pixel and the dark pixel during the concurrent imaging. An indication of ambient light level can be generated according to the difference. The indication can be used as desired, for example to manage the brightness of the display screen.

An advantage over the prior art is that no sensors are required, separately from the imaging array that is already provided for imaging. Nor is it required to expend the space and cost that such separate sensors require. Nor is it required to expend the amount of power that such separate sensors require.

These and other features and advantages of this description will become more readily apparent from the following Detailed Description, which proceeds with reference to the drawings, in which:

### BRIEF DESCRIPTION OF THE DRAWINGS

FIG. 1 is a block diagram of an imaging device made according to embodiments.

FIG. 2 is a diagram of sample components of a device made according to embodiments.

FIG. 3 is a schematic circuit of a pixel pair made to operate according to embodiments.

FIG. 4A is a sample timing diagram of control signals for the pixels of FIG. 3 in an imaging mode according to embodiments.

FIG. 4B is a sample timing diagram of control signals for the pixels of FIG. 3 in an ambient light level sensing mode according to embodiments.

FIG. 5 is a schematic diagram showing how a photodiode current can be measured according to an embodiment where a voltage regulator for a supply current is used.

FIG. 6 is a schematic diagram showing how a difference in photodiode currents can be measured according to an embodiment where a transimpedance amplifier is used.

FIG. 7 is a schematic diagram showing how a difference in photodiode currents can be rendered as a pulse width modulation in an embodiment where a transimpedance amplifier is used.

FIG. 8 is a schematic diagram showing how a difference in photodiode currents can be measured according to an embodiment where a capacitive transimpedance amplifier is used.

FIG. 9 is a schematic diagram showing how a difference in photodiode currents can be rendered as a pulse width modulation in an embodiment where a capacitive transimpedance amplifier is used.

FIG. 10 is a schematic diagram showing how a switched-in voltage regulator can help a photodiode current settle faster, according to an embodiment where a transimpedance amplifier or a capacitive transimpedance amplifier is used to measure a photodiode current difference.

FIG. 11 is a flowchart for illustrating methods according to embodiments.

FIG. 12 depicts a controller-based system for an imaging device made according to embodiments.

### DETAILED DESCRIPTION

As has been mentioned, the present description is about imaging devices and methods, where an ambient light level indication is generated. Embodiments are now described in more detail.

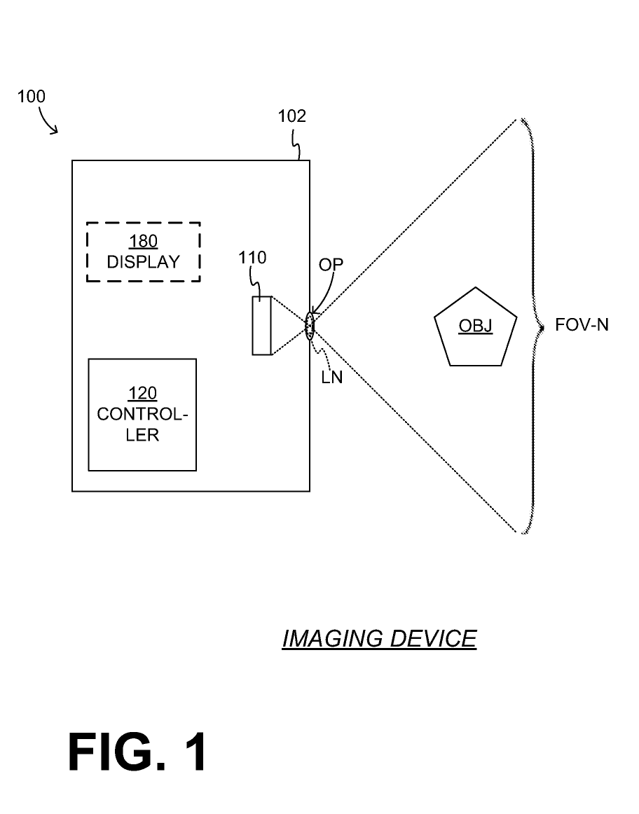

FIG. 1 is a block diagram of an imaging device 100 made according to embodiments. Imaging device 100 has a casing 102, and includes an opening OP in casing 102. A lens LN may be provided optionally at opening OP, although that is not necessary.

Imaging device 100 also has a pixel array 110 made according to embodiments. Pixel array 110 is configured to receive light through opening OP, so imaging device 100 can capture an image of an object OBJ, person, or scene. As can be seen, pixel array 110 and opening OP define a nominal Field of View FOV-N. Of course, Field of View FOV-N and object OBJ are in three dimensions, while FIG. 1 shows them in two dimensions. Further, if lens LN is indeed provided, the resulting actual field of view may be different than the nominal Field of View FOV-N. Imaging device 100 is aligned so that object OBJ, person, or scene that is to be imaged is within the actual field of view.

The pixels of pixel array 110 can capture elements of the image, and can thus be called imaging pixels. In many embodiments, pixel array 110 has a two-dimensional array of pixels. The array can be organized in rows and columns.

Device 100 can render the image from the elements captured by the pixels. Optionally, device 100 also includes a display screen 180 that can display the rendered image, or a version of it.

Device 100 additionally includes a controller 120. Controller 120 may control the operation of pixel array 110 and other components of imaging device 100, by transmitting control signals. Controller 120 may optionally be formed integrally with pixel array 110, and possibly also with other components of imaging device 100.

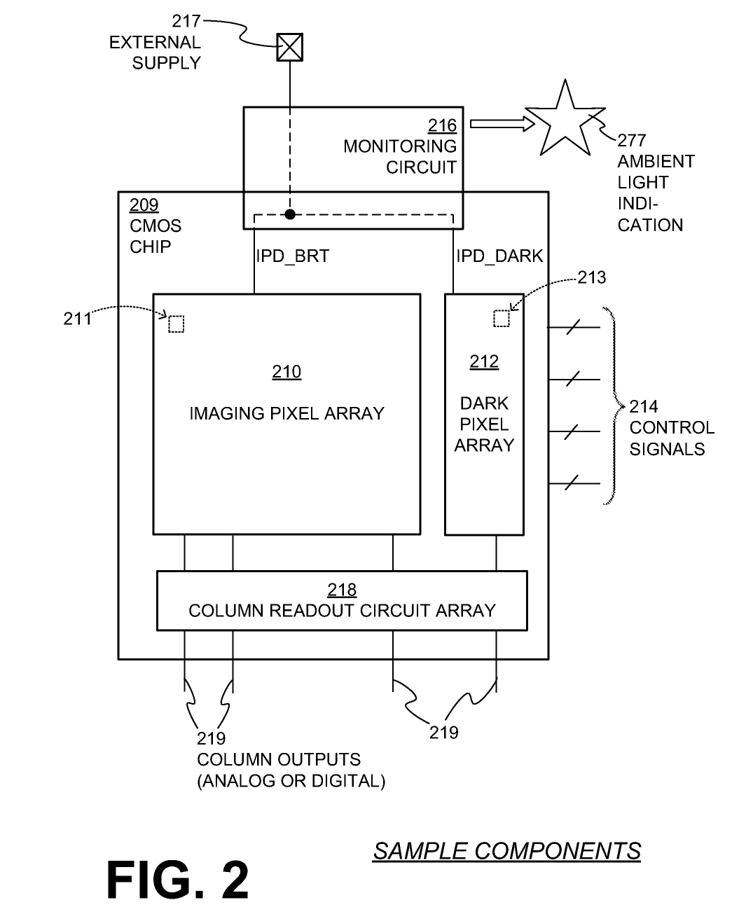

FIG. 2 is a diagram of sample components of an imaging device made according to embodiments. The components of FIG. 2 include a CMOS chip 209. CMOS chip 209 may advantageously contain a number of components.

CMOS chip 209 has an imaging pixel array 210 that contains imaging pixels. As an example, a certain imaging pixel 211 is also shown. Imaging pixel array 210 may be configured to acquire an image, such as was described with reference to FIG. 1, using the imaging pixels. The imaging pixels are sometimes also called active pixels, and bright pixels. The imaging pixels can be black and white pixels or color pixels. In the latter case, the imaging pixels can be Red, Green and Blue (“RGB”). It will be appreciated that, when the imaging pixels are color pixels, ambient light can be detected for different portions of the visible spectrum.

CMOS chip 209 also includes a dark pixel array 212, which contains dark pixels. As an example, a certain dark pixel 213 is also shown. Ordinarily, the dark pixels of array 214 are used to adjust the image acquired by the imaging pixels. In some instances, they have IR filters, for providing a better reference for the adjustment.

The pixels of arrays 210 and 212 receive control signals 214 from the controller, which is not shown in FIG. 2. The appropriate such control signals 214 enable a mode for imaging, and a mode for sensing ambient light level.

CMOS chip 209 also includes a column readout circuit array 218. Circuit array 218 may receive the outputs of the pixels of arrays 210, 212, and provide column outputs 219. Column outputs 219 may be in analog or digital form, and are provided to a display, a memory, and so on.

The components of FIG. 2 further include a monitoring circuit 216. Monitoring circuit 216 may be provided on or off CMOS chip 209, or a portion can be provided on CMOS chip 209 and another portion off.

The components of FIG. 2 also include an external supply node 217. Supply node 217 may be provided on CMOS chip 209, although that is not necessary. Supply node 217 may provide current to arrays 210 and 212, at various phases. The current provided to the imaging pixels of array 210 while imaging is designated as IPD_BRT, considering that it is consumed by photodiodes. The current provided to the dark pixels of array 212 while imaging is designated as IPD_DARK, based on the same consideration.

The current is shown as being supplied from supply node 217 to arrays 210 and 212 though monitoring circuit 216, with dashed lines. The dashed lines are shown to facilitate comprehension. Monitoring circuit 216 may detect the total current, and/or current IPD_BRT, and/or current IPD_DARK. In addition, any part of these currents may be finally supplied to arrays 210 and 212 by a component of monitoring circuit 216, as will be seen in examples later in this document.

In some embodiments, the controller is configured to cause at least a certain one of the imaging pixels, such as pixel 211, and at least a certain one of the dark pixels, such as pixel 213, to image concurrently. This mode of concurrent imaging is the aforementioned mode of sensing ambient light level. An implementation is now described.

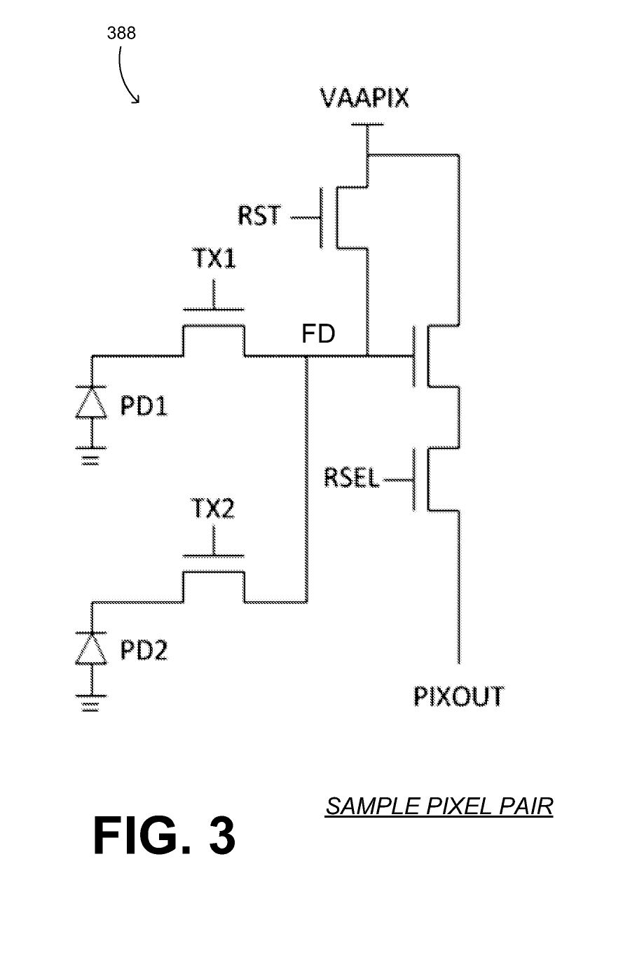

FIG. 3 is a schematic circuit of a sample pixel pair 388 made to operate according to embodiments. The pixels of FIG. 3 are one example of the pixels in array 210 or 212. Pair 388 includes a first pixel and a second pixel, which share some components. The first pixel has a photodiode PD1 and a first transfer gate that receives a Transfer 1 control signal TX1. The second pixel has a photodiode PD2 and a second transfer gate that receives a Transfer 2 control signal TX2. Signals TX1, TX2 may cause the transfer of some or all the charge that has been accumulated by integrating photocurrents from photodiodes PD1, PD2, respectively onto node FD. The first and the second pixels receive a supply current at a voltage VAAPIX, and share a reset gate that receives a Reset control signal RST. In addition, the first and the second pixels share a selection gate that receives a Row Select control signal RSEL. The output of the pixel that has been imaging is output as signal PIXOUT via a shared output line. Accordingly, if the pixels of FIG. 3 are indeed the pixels of arrays 210 and 212, then control signals 214 would include RST, RSEL, TX1 and TX2.

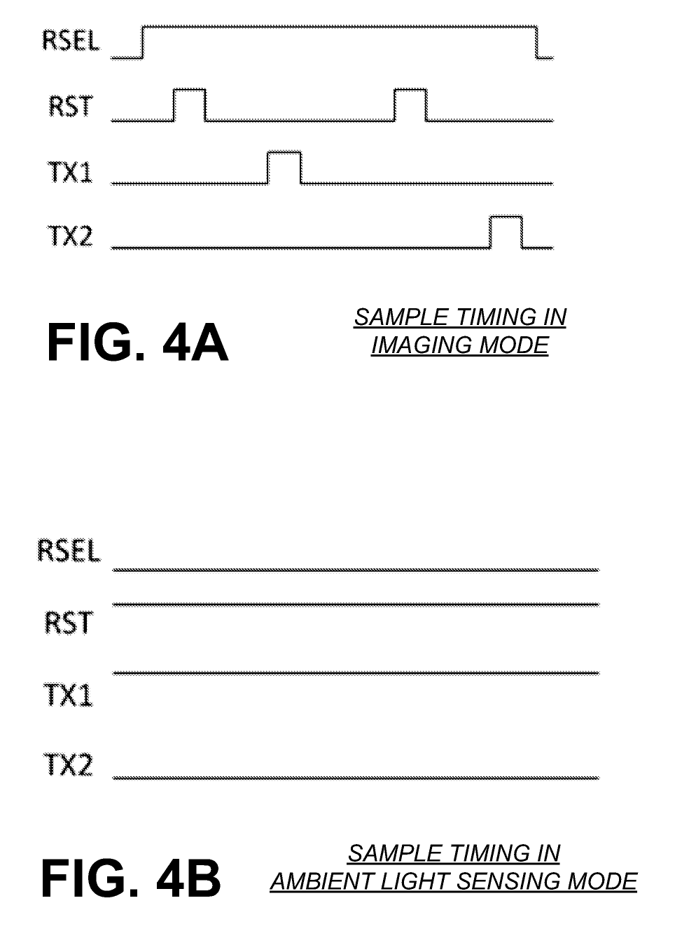

FIG. 4A is a sample timing diagram of control signals for the pixels of FIG. 3 in an imaging mode according to embodiments, which is also sometimes called a CIS mode. FD node is reset by reset signal RST. It will be observed that, when the pixels are selected, there is first a pulse in the reset RST signal and in the transfer gate TX1 signal for the first pixel to transfer integrated photoelectrons and output, and then another pulse in the reset RST and in the transfer gate TX2 for the second pixel to transfer integrated photoelectrons and output.

FIG. 4B is a sample timing diagram of control signals for the pixels of FIG. 3 in an ambient light level sensing mode according to embodiments, which is also sometimes called an ALS mode. RSEL is low, which means neither the first nor the second pixel are producing an output, such as an imaging output, as a signal PIXOUT. RST is high, which means that the FD node shared by the first and the second pixel become coupled with VAAPIX. TX1 is high, which means that the photocurrent of the first pixel can be monitored at VAAPIX. If PD1 is an imaging pixel, its current is part of IPD_BRT. Of course, in the ALS mode, there can more than one imaging pixels connected and have their TX and RST gates turned on. If PD1 is a dark pixel, then its current is part of IPD_DARK.

Returning to FIG. 2, during the concurrent imaging, monitoring circuit 216 may be configured to measure a difference between a current drawn by the certain imaging pixel, and a current drawn by the certain dark pixel. In this example, monitoring circuit 216 could measure a difference between current IPD_BRT drawn by imaging pixel 211, and current IPD_DARK drawn by dark pixel 213. In such embodiments, an indication 277 of ambient light level can be generated according to the measured difference.

Indication 277 may be used in any number of ways. For example, an imaging device may include a display screen, such as display screen 180 of FIG. 1. A brightness of the display screen can be controlled according to the indication.

The difference in the drawn currents may be created in any number of ways. In the example above, current IPD_BRT was solely due to certain imaging pixel 211, and current IPD_DARK was solely due to certain dark pixel 213. An advantage is thus that, when the imaging pixels are color pixels, the difference in the currents can be an ambient light indicator for at least a certain part of the spectrum.

In other embodiments, additional imaging pixels of array 210, plus additional dark pixels of array 212 can be caused to be imaged by suitable control signals, such as control signals 214. It is preferred, but not necessary, that the number of the additional imaging pixels equals the number of the additional dark pixels. It is preferred that the total area of the selected imaging pixels substantially equals the total area of the selected dark pixels. These additional imaging and dark pixels can be caused to be imaged concurrently with certain imaging pixel 211 and certain dark pixel 213, in other words, during the ambient light level sensing mode. In these embodiments, current IPD_BRT would be due to the current drawn by certain imaging pixel 211 plus the additional imaging pixels, and current IPD_DARK would be due to the current drawn by certain dark pixel 213 plus the additional dark pixels. And, in these embodiments, the difference measured by monitoring circuit 216 is a difference between current IPD_BRT and current IPD_DARK.

The difference in the drawn currents may be measured in any number of ways. In some embodiments, a processor is included, and is configured to generate the indication. Examples are now given.

In some embodiments, monitoring circuit 216 subtracts currents IPD_BRT and IPD_DARK in current domain. This way, it can measure the difference from the subtraction.

In other embodiments, monitoring circuit 216 converts currents IPD_BRT and IPD_DARK into respective voltage signals. It may then subtract the voltage signals, and thus measure the difference from the subtraction. The voltage signals may be subtracted in voltage domain, or first become digitized and then subtracted as numbers.

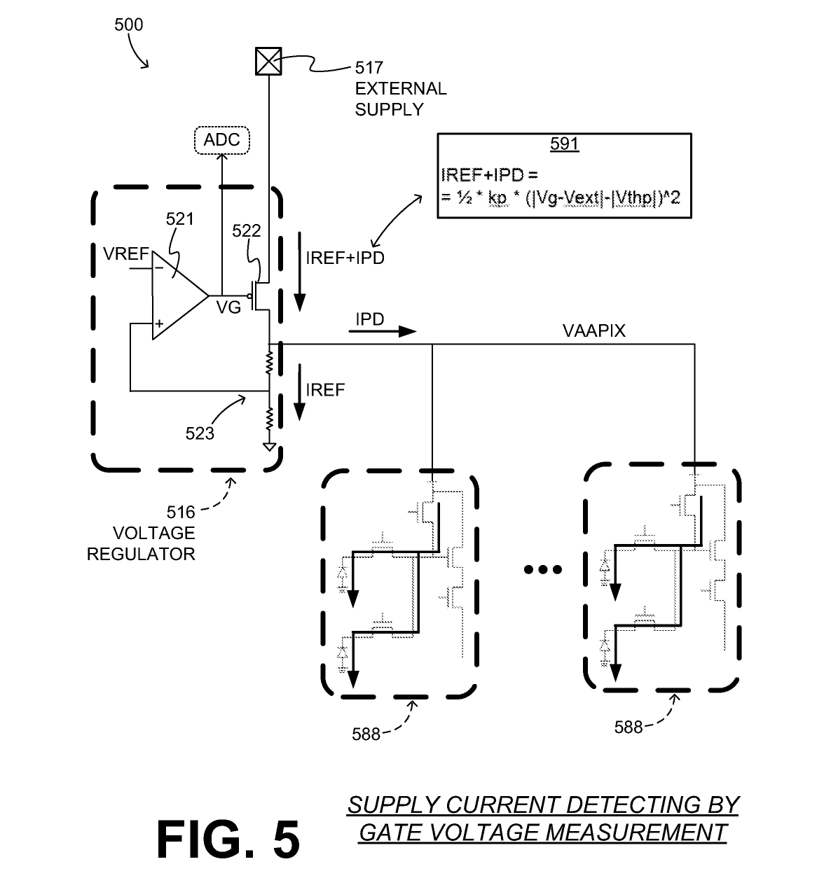

FIG. 5 is a schematic diagram 500 showing how a photodiode current IPD can be measured. An array can have pixel pairs 588, similar to pixel pair 388, either as imaging pixels or as dark pixels or both. An external supply node 517, akin to node 217, provides supply current to pixel pairs 588 when they image. The supply current passes through a voltage regulator 516, which would be part of the monitoring circuit. The voltage signal may be generated at a node of the voltage regulator.

In this example, voltage regulator 516 includes an operational amplifier (“op amp”) 521, a Field Effect Transistor (FET) 522, and a resistive divider 523. Resistive divider 523 drains a reference current IREF from supply node 517, and establishes a voltage VAAPIX that supplies bias voltage to photodetectors in pixel pairs 588. In addition, a current flow IPD equals the total photocurrent supplied to pixel pairs 588. At the node between op amp 521 and the gate of FET 522, a voltage VG is established. Voltage VG is a voltage signal from which photodetector IPD can become known, as shown by equation 591. A person skilled in the art will notice that the change in IPD varies as a square of a change of VG, and may make appropriate adjustments. Optionally, voltage VG is digitized by being sent to an Analog to Digital Converter (ADC), and so on.

In some embodiments, the currents are converted into the respective voltage signals using a transimpedance amplifier. Examples are now described.

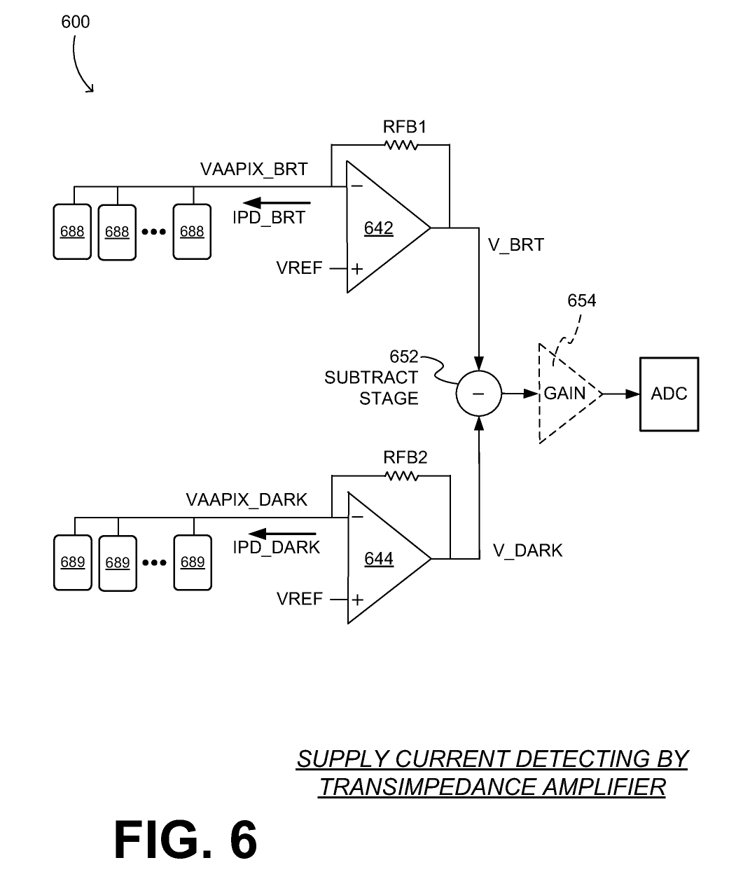

FIG. 6 is a schematic diagram 600. Imaging pixels 688, which could also be imaging pixel pairs, receive current IPD_BRT at a voltage VAAPIX_BRT during an ambient light level sensing mode. A voltage V_BRT is produced by an op amp 642 and a feedback resistor RFB1 arranged as a transimpedance amplifier that is set at a reference voltage VREF. The value of voltage V_BRT is given by VREF+IPD_BRT*RFB1. It will be observed that V_BRT varies linearly with IPD_BRT.

Similarly, dark pixels 689, which could also be dark pixel pairs, receive current IPD_DARK at a voltage VAAPIX_DARK during the ambient light level sensing mode. A voltage V_DARK is produced by an op amp 644 and a feedback resistor RFB2 also arranged as a transimpedance amplifier set at reference voltage VREF. The value of voltage V_DAK is given by VREF+IPD_DARK*RFB2. Preferably, RFB1=RFB2.

A subtract stage 652 subtracts voltages V_BRT and V_DRK. The difference is optionally passed through a gain stage 654, and may then become digitized through an ADC. The difference serves as indication 277 of ambient light level.

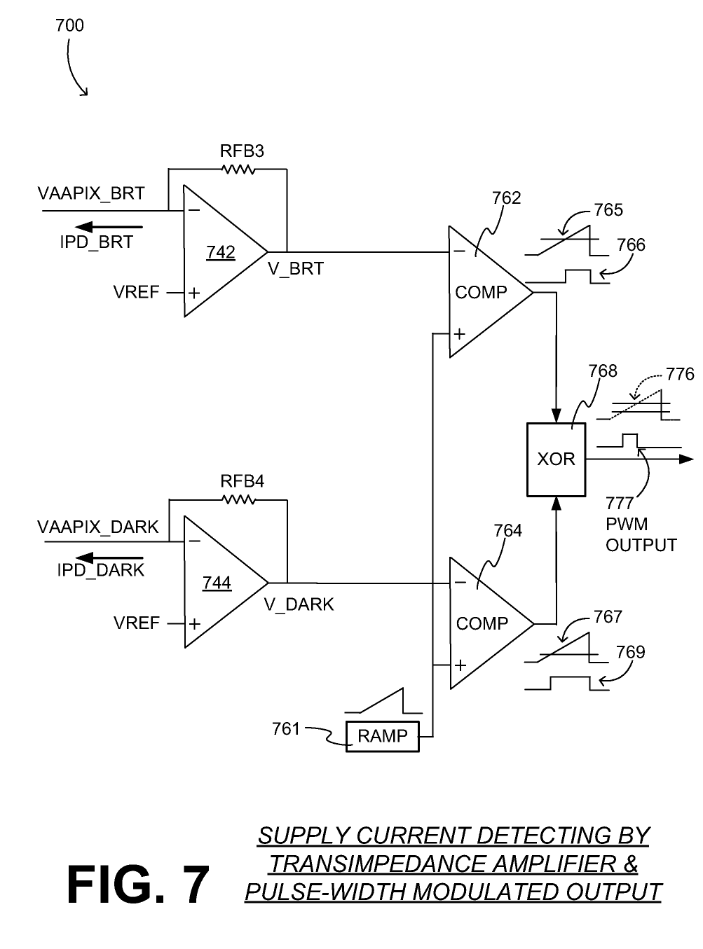

FIG. 7 is a schematic diagram 700, which is a possible alternate ending for the circuit of diagram 600. A transimpedance amplifier is implemented with an op amp 742 and feedback resistor RFB3 to output a voltage V_BRT, which is a measure of IPD_BRT. Similarly, a transimpedance amplifier is implemented with op amp 744 and feedback resistor RFB4 to output a voltage V_DARK, which is a measure of IPD_DARK. Preferably, RFB3=RFB4. Voltage signals V_BRT and V_DARK are input in respective comparators 762, 764, where they are compared with a ramp from a ramp generator 761. Waveform 765 indicates the comparison at comparator 762, where the output result is a pulse in a waveform 766. Similarly, waveform 767 indicates the comparison at comparator 764, where the output result is a pulse in a waveform 769. The outputs of comparators 762, 764 are input into an XOR gate 768. What is really compared is pulse 766 and pulse 769. Waveform segment 776 shows a combination of waveforms 765, 767 for easier comprehension. The result is a Pulse Width Modulation (PWM) waveform segment 777, which has a pulse. The difference between V_BRT and V_DARK is thus related to the width of the pulse in waveform segment 777. Thus, the width serves as indication 277 of ambient light level. A change in the ambient light level is rendered as pulse width modulation.

In some embodiments, the currents are converted into the respective voltage signals using a capacitive transimpedance amplifier. Examples are now described.

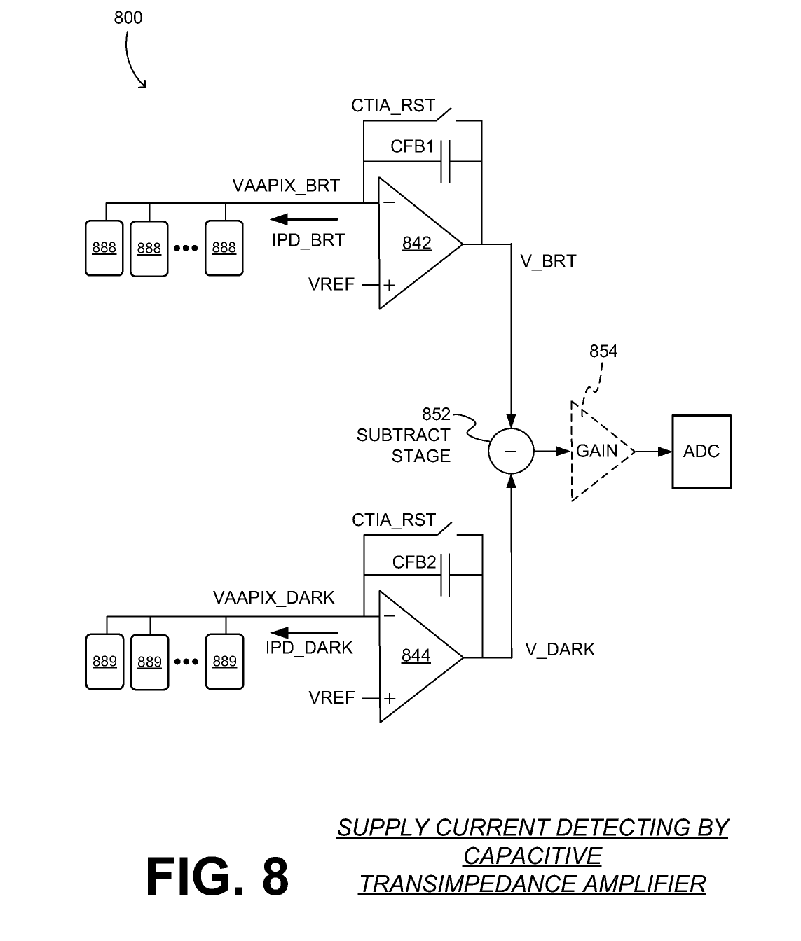

FIG. 8 is a schematic diagram 800. Imaging pixels 888, which could also be imaging pixel pairs, receive current IPD_BRT at a voltage VAAPIX_BRT during an ambient light level sensing mode. A voltage V_BRT is produced by an op amp 842 and a feedback capacitor CFB1 arranged as a capacitive transimpedance amplifier that is set at a reference voltage VREF. The value of voltage V_BRT is given by VREF+IPD_BRT/CFB1*TINT, where TINT is the integration time. It will be observed that V_BRT varies linearly with IPD_BRT.

Similarly, dark pixels 889, which could also be dark pixel pairs, receive current IPD_DARK at a voltage VAAPIX_DARK during the ambient light level sensing mode. A voltage V_DARK is produced by an op amp 844 and a feedback capacitor CFB2 also arranged as a capacitive transimpedance amplifier set at reference voltage VREF. The value of voltage V_DARK is given by VREF+IPD_DARK/CFB2*TINT. Preferably, CFB1=CFB2.

The operation of both capacitive transimpedance amplifiers is controlled by a switch that responds to a reset signal CTIA_RST. A subtract stage 852 subtracts voltages V_BRT and V_DRK. The difference is optionally passed through a gain stage 854, and may then become digitized through an ADC. Gain stage is optional, as gain control can be done by varying TINT. The difference serves as indication 277 of ambient light level.

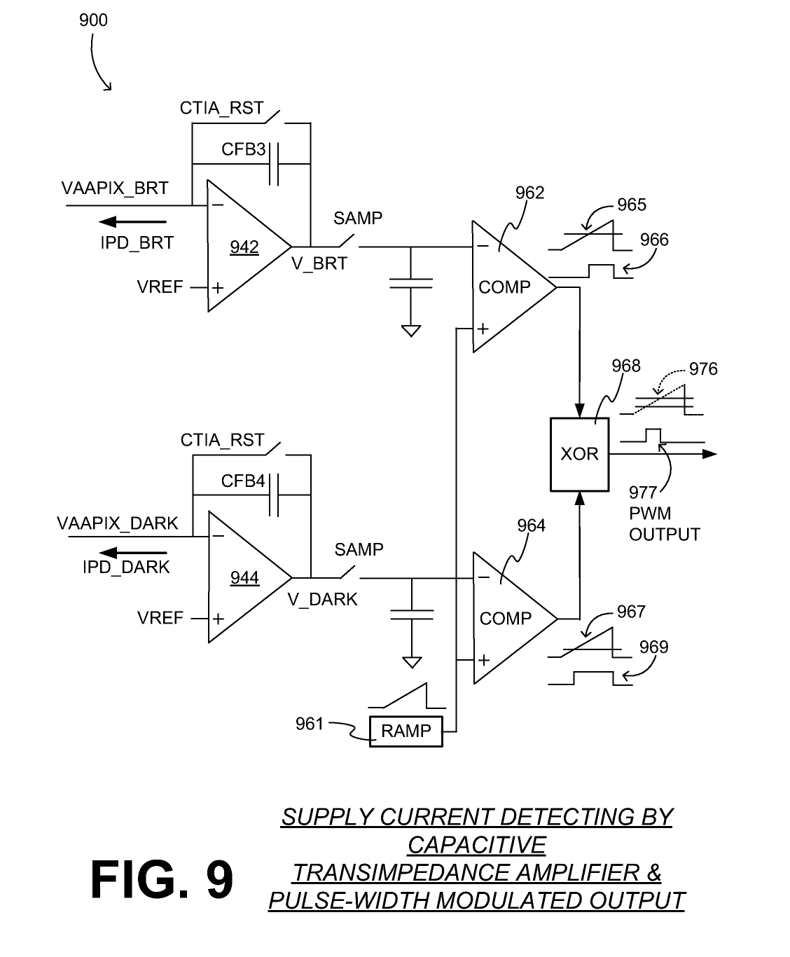

FIG. 9 is a schematic diagram 900, which is a possible alternate ending for the circuit of diagram 800. A capacitive transimpedance amplifier is implemented with an op amp 942 and feedback capacitor CFB3 to output a voltage V_BRT, which is a measure of IPD_BRT. Similarly, a capacitive transimpedance amplifier is implemented with op amp 944 and feedback capacitor CFB4 to output a voltage V_DARK, which is a measure of IPD_DARK. Preferably, CFB3=CFB4. Voltage signals V_BRT and V_DARK are sampled by a switch according to a signal SAMP after integration is finished. At that time, reset signal CTIA_RST is open (“off”). Then, the sampled V_BRT and V_DARK are input in respective comparators 962, 964, where they are compared with a ramp from a ramp generator 961. Waveform 965 indicates the comparison at comparator 962, where the output result is a pulse in a waveform 966. Similarly, waveform 967 indicates the comparison at comparator 964, where the output result is a pulse in a waveform 969. The outputs of comparators 962, 964 are input into an XOR gate 968. What is really compared is pulse 966 and pulse 969. Waveform segment 976 shows a combination of waveforms 965, 967 for easier comprehension. The result is a PWM waveform segment 977, which has a pulse. The difference between V_BRT and V_DARK is thus related to the width of the pulse in waveform segment 977. Thus, the width serves as indication 277 of ambient light level. A change in the ambient light level is rendered as pulse width modulation.

In FIGS. 6, 7, 8, 9, during the mode of sensing ambient light level, current IPD_BRT and/or current IPD_DARK is provided exclusively from the amplifiers. In these embodiments, if a voltage regulator is provided, it is disconnected and/or disabled.

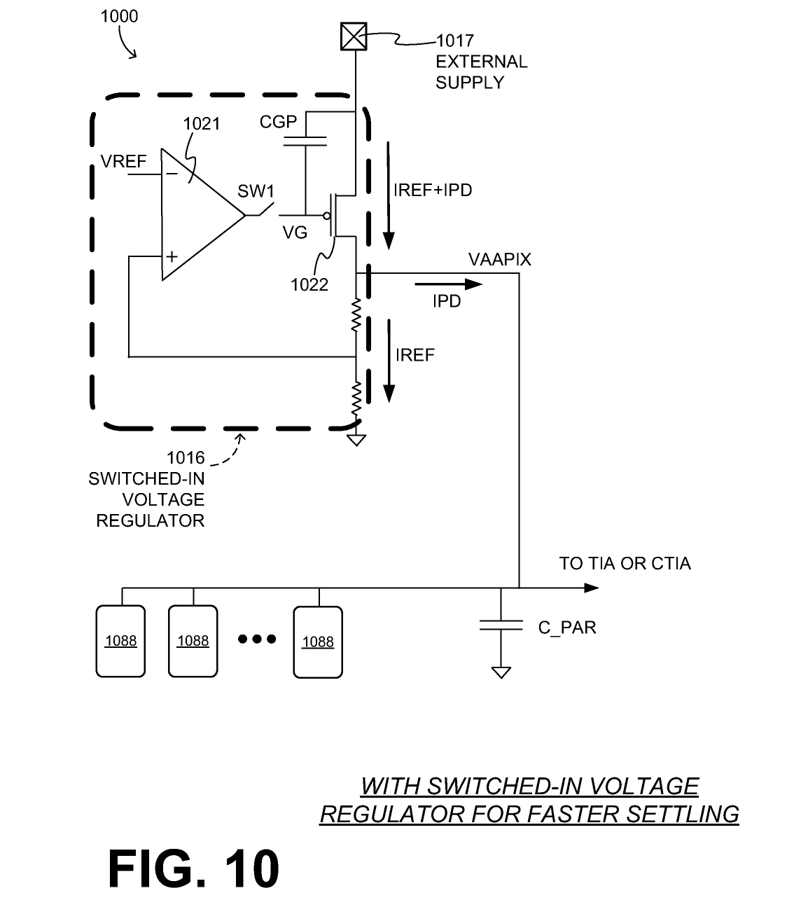

FIG. 10 is a schematic diagram 1000, which is a possible alternate beginning for the circuit of diagram 600 or 800. Pixels 1088 could be pixels 688, 689, 888, or 889. Pixels 1088 are coupled in parallel with a capacitor C_PAR of preferably a very large value. Pixels 1088 are also coupled with a transimpedance amplifier or a capacitive transimpedance amplifier where indicated. An external supply node 1017 supplies current to pixels 1088. A switched-in voltage regulator 1016 regulates a voltage VAAPIX of the current that is applied to pixels 1088, somewhat similarly to what was described in FIG. 5. Voltage regulator 1016 includes an op amp 1021, a FET 1022, and a capacitor CGP. A switch SW1 can connect and disconnect an output of op amp 1021 from the gate of FET 1022. The operation of switch SW1 can be understood also with reference to FIG. 3, in an example where schematic 388 is substituted in pixel 1088. In a first phase, switch SW1 is closed, the RST signal is turned on and the VG level can be sampled, perhaps on capacitor CGP, which thus provides a measurement of current light condition. This measurement can also help for setting the voltage level of VAAPIX. The latter could alternately be done using the TIA or CTIA, but that would take longer. In a second phase, switch SW1 is opened, and one or more of the gates are turned on with a TX1 or TX2 signal, to start the current measurement. When switch SW1 is opened, there is a fixed current going through the output branch of regulator 1016. When the lighting condition changes, this current can be canceled out.

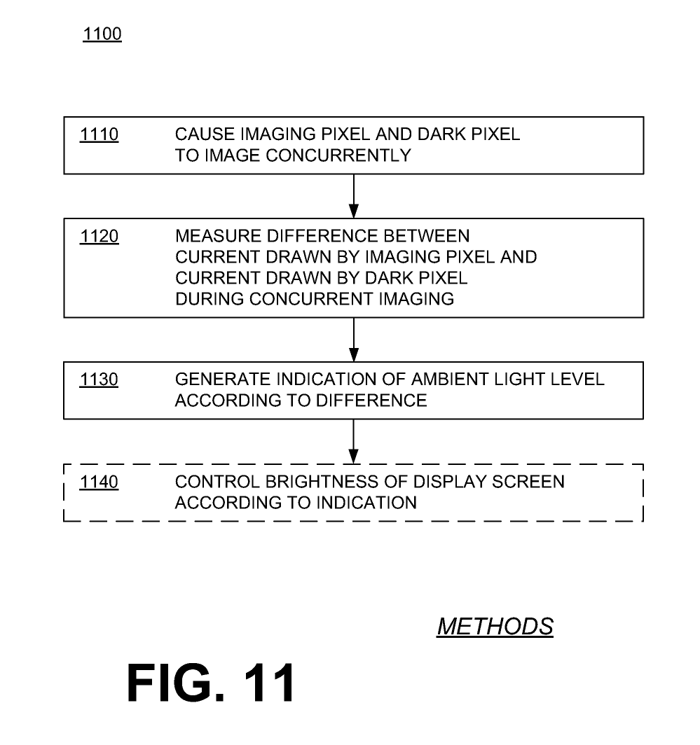

FIG. 11 shows a flowchart 1100 for describing methods according to embodiments. The methods of flowchart 1100 are for an imaging device that has an array of imaging pixels configured to acquire an image and a plurality of dark pixels, and may also be practiced by embodiments described above, as described above.

According to an operation 1110, at least a certain one of the imaging pixels and at least a certain one of the dark pixels are caused to image concurrently. Optionally, additional imaging pixels and additional dark pixels are caused to be imaged concurrently with the certain imaging pixel and the certain dark pixel. In some embodiments, the number of the additional imaging pixels equals the number of the additional dark pixels. Plus, the total area of the imaging pixels could equal to the total area of the dark pixels.

According to another operation 1120, a difference is measured between a current drawn by the certain imaging pixel and a current drawn by the certain dark pixel during the concurrent imaging. If additional pixels have been caused to image concurrently, the measured difference is a difference between a current drawn by the certain imaging pixel plus the additional imaging pixels, and a current drawn by the certain dark pixel plus the additional dark pixels during the concurrent imaging.

The difference can be measured in any number of ways. For example, the difference can be measured by subtracting the currents in current domain. Or, the difference can be measured by converting the currents into respective voltage signals, and then subtracting the voltage signals. The currents can be converted into voltage signals using a transimpedance amplifier, or a capacitive transimpedance amplifier. The voltage signals could be digitized before being subtracted.

According to another operation 1130, an indication of ambient light level is generated, according to the difference.

When the imaging device also includes a display screen, according to another, optional operation 1140, a brightness of the display screen is further controlled according to the indication.

These operations can be in a mode of sensing ambient light level. This mode can alternate with a regular imaging mode. So, the certain imaging pixel and the additional imaging pixels can be caused to capture an image prior to the concurrent imaging, or after the concurrent imaging.

In the methods described above, each operation can be performed as an affirmative step of doing, or causing to happen, what is written that can take place. Such doing or causing to happen can be by the whole system or device, or just one or more components of it. In addition, the order of operations is not constrained to what is shown, and different orders may be possible according to different embodiments. Moreover, in certain embodiments, new operations may be added, or individual operations may be modified or deleted. The added operations can be, for example, from what is mentioned while primarily describing a different system, device or method.

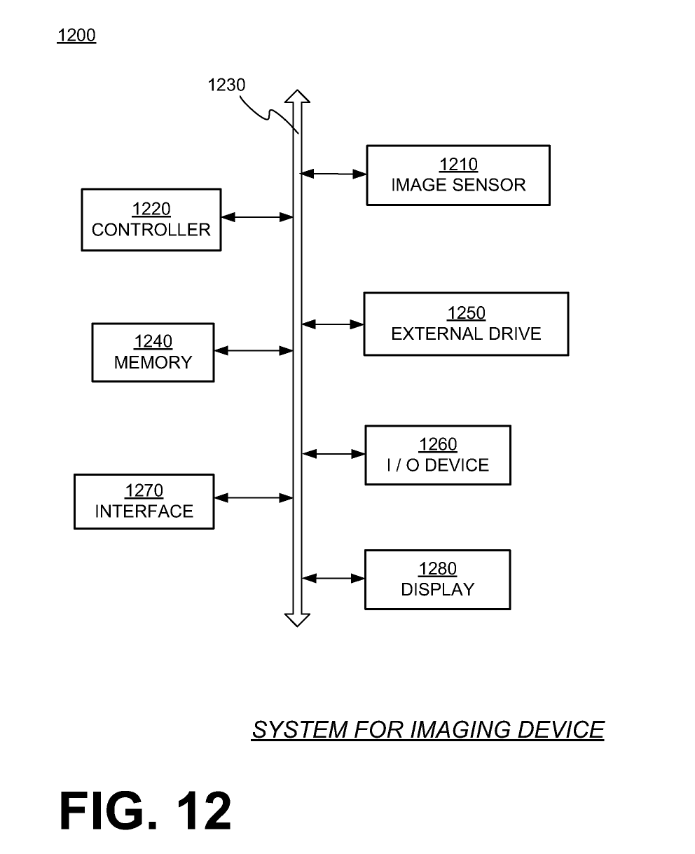

FIG. 12 depicts a controller-based system 1200 for an imaging device made according to embodiments. System 1200 could be for device 100 of FIG. 1.

System 1200 includes an image sensor 1210, which is made according to embodiments, such as by a pixel array. As such, system 1200 could be, without limitation, a computer system, an imaging device, a camera system, a scanner, a machine vision system, a vehicle navigation system, a smart telephone, a video telephone, a personal digital assistant (PDA), a mobile computer, a surveillance system, an auto focus system, a star tracker system, a motion detection system, an image stabilization system, a data compression system for high-definition television, and so on.

System 1200 further includes a controller 1220, which is made according to embodiments. Controller 1220 could be controller 120 of FIG. 1. Controller 1220 could be a Central Processing Unit (CPU), a digital signal processor, a microprocessor, a microcontroller, an application-specific integrated circuit (ASIC), a programmable logic device (PLD), and so on. In some embodiments, controller 1220 communicates, over bus 1230, with image sensor 1210. In some embodiments, controller 1220 may be combined with image sensor 1210 in a single integrated circuit. Controller 1220 controls and operates image sensor 1210, by transmitting control signals from output ports, and so on, as will be understood by those skilled in the art.

Controller 1220 may further communicate with other devices in system 1200. One such other device could be a memory 1240, which could be a Random Access Memory (RAM) or a Read Only Memory (ROM), or a combination. Memory 1240 may be configured to store instructions to be read and executed by controller 1220. Memory 1240 may be configured to store images captured by image sensor 1210, both for short term and long term.

Another such device could be an external drive 1250, which can be a compact disk (CD) drive, a thumb drive, and so on. One more such device could be an input/output (I/O) device 1260 for a user, such as a keypad, a keyboard, and a display. Memory 1240 may be configured to store user data that is accessible to a user via the I/O device 1260.

An additional such device could be an interface 1270. System 1200 may use interface 1270 to transmit data to or receive data from a communication network. The transmission can be via wires, for example via cables, or USB interface. Alternately, the communication network can be wireless, and interface 1270 can be wireless and include, for example, an antenna, a wireless transceiver and so on. The communication interface protocol can be that of a communication system such as CDMA, GSM, NADC, E-TDMA, WCDMA, CDMA2000, Wi-Fi, Muni Wi-Fi, Bluetooth, DECT, Wireless USB, Flash-OFDM, IEEE 802.20, GPRS, iBurst, WiBro, WiMAX, WiMAX-Advanced, UMTS-TDD, HSPA, EVDO, LTE-Advanced, MMDS, and so on.

One more such device can be a display 1280. Display 1280 could be display 180 of FIG. 1. Display 1280 can show to a user a tentative image that is received by image sensor 1210, so to help them align the device, perhaps adjust imaging parameters, and so on.

This description includes one or more examples, but that does not limit how the invention may be practiced. Indeed, examples or embodiments of the invention may be practiced according to what is described, or yet differently, and also in conjunction with other present or future technologies.

A person skilled in the art will be able to practice the present invention in view of this description, which is to be taken as a whole. Details have been included to provide a thorough understanding. In other instances, well-known aspects have not been described, in order to not obscure unnecessarily the present invention.

Other embodiments include combinations and sub-combinations of features described herein, including for example, embodiments that are equivalent to: providing or applying a feature in a different order than in a described embodiment; extracting an individual feature from one embodiment and inserting such feature into another embodiment; removing one or more features from an embodiment; or both removing a feature from an embodiment and adding a feature extracted from another embodiment, while providing the advantages of the features incorporated in such combinations and sub-combinations.

The following claims define certain combinations and subcombinations of elements, features and steps or operations, which are regarded as novel and non-obvious. Additional claims for other such combinations and subcombinations may be presented in this or a related document.

What is claimed is:

1. An imaging device, comprising:
an array of imaging pixels configured to acquire an image;
an array of dark pixels;
a controller configured to cause at least a certain one of the imaging pixels and at least a certain one of the dark pixels to image concurrently; and
a monitoring circuit configured to measure a difference between a current drawn by the certain imaging pixel, and a current drawn by the certain dark pixel during the concurrent imaging, and
in which an indication of ambient light level is generated according to the measured difference.

2. The device of claim 1, further comprising:
a display screen, and
in which a brightness of the display screen is controlled according to the indication.

3. The device of claim 1, in which
additional ones of the imaging pixels and additional ones of the dark pixels are caused to be imaged concurrently with the certain imaging pixel and the certain dark pixel, and
the difference measured by the monitoring circuit is a difference between a current drawn by the certain imaging pixel plus the additional imaging pixels, and a current drawn by the certain dark pixel plus the additional dark pixels during the concurrent imaging.

4. The device of claim 3, in which
a number of the additional imaging pixels equals a number of the additional dark pixels.

5. The device of claim 3, in which
a total area of the additional imaging pixels equals a total area of the additional dark pixels.

6. The device of claim 1, further comprising:
a processor configured to generate the indication.

7. The device of claim 1, in which
the monitoring circuit subtracts the currents in current domain.

8. The device of claim 1, in which
the monitoring circuit converts the currents into respective voltage signals, and then subtracts the voltage signals.

9. The device of claim 8, in which
the voltage signals are digitized before being subtracted.

10. The device of claim 8, in which
the monitoring circuit further includes a voltage regulator that supplies the current drawn by the certain imaging pixel, and
the voltage signal is generated at a node of the voltage regulator.

11. The device of claim 8, in which
the currents are converted into the respective voltage signals using a transimpedance amplifier.

12. The device of claim 11, in which
the monitoring circuit further includes a voltage regulator that supplies the current drawn by the certain imaging pixel.

13. The device of claim 8, in which
the currents are converted into the respective voltage signals using a capacitive transimpedance amplifier.

14. The device of claim 13, in which
the monitoring circuit further includes a voltage regulator that supplies the current drawn by the certain imaging pixel.

15. The device of claim 13, in which
the indication is expressed in terms of a pulse width.

16. A method for an imaging device having an array of imaging pixels configured to acquire an image and a plurality of dark pixels, the method comprising:
causing at least a certain one of the imaging pixels and at least a certain one of the dark pixels to image concurrently;
measuring a difference between a current drawn by the certain imaging pixel and a current drawn by the certain dark pixel during the concurrent imaging; and
generating an indication of ambient light level according to the difference.

17. The method of claim 16, in which
the imaging device further includes a display screen, and
further comprising: controlling a brightness of the display screen according to the indication.

18. The method of claim 16, in which
additional imaging pixels and additional dark pixels are caused to be imaged concurrently with the certain imaging pixel and the certain dark pixel, and
the measured difference is a difference between a current drawn by the certain imaging pixel plus the additional imaging pixels, and a current drawn by the certain dark pixel plus the additional dark pixels during the concurrent imaging.

19. The method of claim 18, in which
a number of the additional imaging pixels equals a number of the additional dark pixels.

20. The method of claim 18, in which
a total area of the additional imaging pixels equals a total area of the additional dark pixels.

21. The method of claim 16, in which
the difference is measured by subtracting the currents in current domain.

22. The method of claim 16, in which
the difference is measured by converting the currents into respective voltage signals, and then subtracting the voltage signals.

23. The method of claim 22, in which
the currents are converted into respective voltage signals using a transimpedance amplifier.

24. The method of claim 22, in which
the currents are converted into respective voltage signals using a capacitive transimpedance amplifier.

25. The method of claim 22, in which
the voltage signals are digitized before being subtracted.

26. The method of claim 16, further comprising:
causing the certain imaging pixel and the additional imaging pixels to capture an image prior to the concurrent imaging.

27. The method of claim 16, further comprising:
causing the certain imaging pixel and the additional imaging pixels to capture an image after the concurrent imaging.
